(19) United States
(12) Patent Application Publication
(10) Pub. No.: US 2004/0088465 A1
(43) Pub. Date: May 6, 2004

(54) Docking station

(76) Inventor: Mark John Bianchi, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/289,017

(22) Filed: Nov. 6, 2002

(51) Int. Cl. G06F 13/00

(52) U.S. Cl. 710/303

(57) ABSTRACT

A docking station may comprise first, second, and third ports. The first port may be connectable to a computer, the second port may be connectable to a digital imaging device, and the third port may be connectable to at least one peripheral device. The computer may function as a host for the peripheral device when the computer is connected to the first port. The digital imaging device may function as a host for the peripheral device when the computer is not connected to the first port and the digital imaging device is connected to the second port.

### BACKGROUND

Docking stations are devices that enable a first electronic device, such as a digital imaging device, to be easily connected to a second electronic device, such as a computer. The docking station typically provides for rapid connection and disconnection between the electronic devices. For example, the docking station may have a cradle or the like that is configured to physically receive the first electronic device. Conductors or connectors within the cradle may serve to electrically connect the first electronic device to the cradle. These conductors are directly or operatively connected to the second electronic device. Accordingly, the first electronic device becomes directly or operatively connected to the second electronic device upon placement of the first electronic device into the cradle.

One type of data transfer protocol used by the first and second electronic devices and the docking station is a Universal Serial Bus (USB). In the USB protocol, one electronic device functions as a USB host and the other electric device functions as a USB device. The USB host, in summary, controls the operation of the USB devices. The USB host is typically a computer and the USB devices are typically peripheral devices connected to the computer. In one example, a computer functioning as the host may control the operation of a digital imaging device by way of a docking station. USB conductors within the docking station simply pass through the docking station to connect the first and second electronic devices. Thus, the digital imaging device becomes electrically connected to the computer using the USB protocol.

The use of a docking station as described above enables a user to connect a digital imaging device to a computer simply by setting the digital imaging device within a cradle on the docking station. This connection of the digital imaging device to the computer enables the user of the computer to readily control the functions of the digital imaging device. For example, the user may download image data from the digital imaging device. The user may then transmit the data to a printer, which prints an image represented by the image data.

The aforementioned method of docking the digital imaging device and subsequently printing images only works if the computer is active or otherwise on. If the computer is not active, the user may have to wait for the computer to boot up, which may be time consuming. In the alternative, the user may disconnect the printer from the computer and connect the digital imagine device directly to the printer, which may be cumbersome.

### SUMMARY

A docking station for peripheral devices is disclosed herein. One embodiment of the docking station may comprise first, second, and third ports. The first port may be connectable to a computer, the second port may be connectable to a digital imaging device, and the third port may be connectable to at least one peripheral device. The computer may function as a host for the peripheral device when the computer is connected to the first port. The digital imaging device may function as a host for the peripheral device when the computer is not connected to the first port and the digital imaging device is connected to the second port.

A method for transmitting image data from an imaging device to a peripheral device is also disclosed herein. The method may comprise electrically connecting the imaging device to a docking station and electrically connecting a printing device to the docking station. The docking station may detect whether a computer is connected to the docking station. If a computer is not connected to the docking station the imaging device is enabled to function as a host. If a computer is connected to the docking station, the computer is enabled to function as a host and the image data is transmitted to the computer. The method may conclude by transmitting the image data from the host to the printer, wherein the transmitting causes the printer to print an image represented by the image data.

### BRIEF DESCRIPTION OF THE DRAWINGS

FIG. 1 is a schematic illustration of an embodiment of a computer system.

FIG. 2 is a schematic illustration of the configuration of a Universal Serial Bus.

FIG. 3 is a perspective view of an embodiment of the docking station of FIG. 1.

FIG. 4 is a flowchart describing an embodiment of the operation of the computer system of FIG. 1.

FIG. 5 is a schematic illustration of an embodiment of the computer system of FIG. 1 with the computer disconnected or inactive.

FIG. 6 is a schematic illustration of an embodiment of the computer system of FIG. 1.

FIG. 7 is a flowchart summarizing an embodiment of the operation of the computer system of FIG. 6.

### DETAILED DESCRIPTION

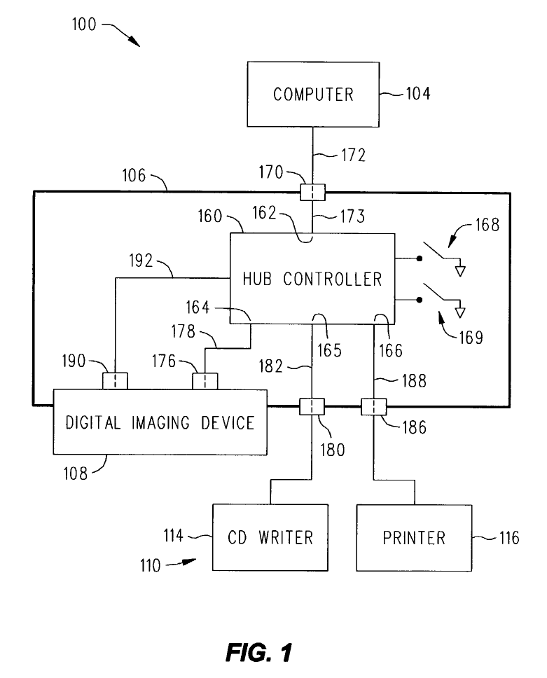

A schematic illustration of an embodiment of a computer system 100 is disclosed in FIG. 1. The computer system 100 may include a computer 104, a docking station 106, a digital imaging device 108 (sometimes referred to simply as an imaging device), and peripheral devices 110. The imaging device 108 may, as an example, be a digital camera. The peripheral devices 110 may include a compact disc writer 114 (sometimes referred to as a CD writer) and a printer 116 that are both connectable to the docking station 106. It should be noted that the CD writer 114 is an example of a data storage device and that other storage devices, such as magnetic storage devices may be connectable to the docking station 106. It should also be noted that other peripheral devices may be connectable to the docking station 106.

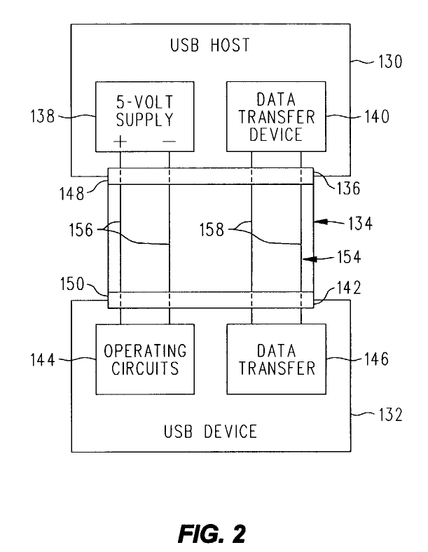

The components of the computer system 100 may be electrically connectable by a data transfer means. In the non-limiting embodiment described herein, the data transfer means is a Universal Serial Bus (sometimes referred to simply as a USB). It is to be understood that data transfer means other than a USB may be used by the computer system 100. A summary of an embodiment of a USB configuration is shown in FIG. 2. The USB configuration has a USB host 130 connected to a USB device 132 by a USB cable 134. The USB host 130 may, as a non-limiting example, be a computer similar to the computer 104 of FIG. 1. The USB device 132 may, as a non-limiting example, be a device similar to the imaging device 108 or the printer 116 of FIG. 1.

The USB host 130 may have a USB-A receptacle 136 that interfaces with the USB cable 134. The USB host 130 may also have a five-volt power supply 138 and a data transfer device 140 connected to the USB-A receptacle 136. Accordingly, the USB host 130 has four conductors connected to the USB-A receptacle 136. As described in greater detail below, the five-volt power supply 138 may supply electric power to the USB device 132. The data transfer device 140 may serve to receive data from and transmit data to the USB device 132.

The USB device 132 may have a USB-B receptacle 142 that interfaces with the USB cable 134. The USB device 132 may also have operating circuits 144 and a data transfer device 146 connected to the USB-B receptacle 142. Like the USB host 130, the USB device 132 may also have four conductors connected to the USB-B receptacle 142. The operating circuits 144 may receive electric power from the five-volt power supply 138 in the USB host 130 to operate circuits within or connected to the USB device 132. For example, in the embodiment of the USB device 132 being a digital imaging device, the operating circuits 144 may include memory devices that store machine-readable image data (referred to herein simply as image data). It should be noted that the five-volt power supply 138 may also supply electric power to operate the data transfer device 146. The data transfer device 146 may serve to transmit data to and receive data from the USB host 130 similar to the data transfer device 140 in the USB host 130.

As described above, the USB cable 134 connects the USB host 130 to the USB device 132. The USB host 130 has been described herein as being a computer and the USB device 132 has been described herein as being a peripheral device, such as a digital imaging device. In the computer system 100, FIG. 1, described herein, the digital imaging device 108 may be capable of serving as the USB host 130 and another peripheral device, such as a printer, may serve as the USB device 132. Accordingly, in the embodiments described herein, the imaging device 108 may control the operation of the printer 116.

Having summarily described the Universal Serial Bus and the USB cable 134, description of the computer system 100 of FIG. 1 will now continue.

The docking station 106 may have a hub controller 160 that is connected to a plurality of ports and other devices as described in greater detail below. Accordingly, the hub controller 160 may have a plurality of ports. Some of the ports of the hub controller 160 are a host port 162, a first device port 164, a second device port 165, and a third device port 166. The hub controller 160 routes data as though the device connected to the host port 162 is a host, such as a USB host. In one embodiment of the hub controller 160, the hub controller 160 may reconfigure the ports based on the device connected to the docking station 106 that is functioning as a host. More specifically, the hub controller 160 may configure the ports so that the host port 162 is operatively connected to the device that is functioning as the host.

As briefly described above, the docking-station 106 may have a plurality of ports located thereon. One of these ports is a first port 170, which is sometimes referred to herein as the computer port 170. A first cable 172, sometimes referred to as the computer cable 172, may be electrically connectable between the computer port 170 and the computer 104. In an embodiment wherein the computer cable 172 is a USB cable, the computer port 170 may be a USB-B receptacle as described in reference to FIG. 2. A USB-A receptacle may be located on the computer 104 to receive the other end of the computer cable 172. A line 173 connects the computer port 170 to a port on the hub controller 160. In the embodiment of FIG. 1, the computer 104 functions as the host; therefore, the port to which the line 173 is connected is configured to be the host port 162.

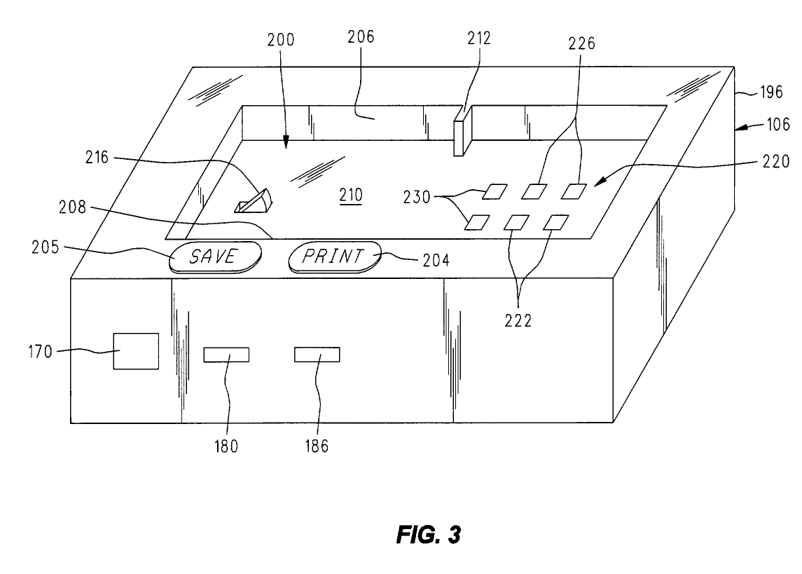

The docking station 106 may also have a second port located thereon. The second port is sometimes referred to as the digital imaging device port 176. In the non-limiting embodiment described herein, the digital imaging device port 176 has contacts located on the housing of the docking station 106. These contacts are described in greater detail below with reference to FIG. 3. The digital imaging device port 176 may be connected to the hub controller 160 by way of a digital imaging device line 178. In the embodiment of the hub controller 160 of FIG. 1, the digital imaging device line 178 is connected to the first device port 164. In one embodiment, the digital imaging device line 178 is configured to operate in the same manner as the USB cable 134 of FIG. 2. It should be noted that in one embodiment of the docking station 106, the digital imaging device port 176 may be a USB receptacle, such as a USB-A or a USB-B receptacle.

Third and fourth ports may connect peripherals 110 to the docking station 106. The third port is sometimes referred to as the CD writer port 180. A CD writer line 182 may connect the CD writer port 180 to the hub controller 160. As shown in FIG. 1, the CD writer line 182 is connected to the second device port 165. The fourth port is sometimes referred to as the printer port 186. A printer line 188 may connect the printer line 188 to the hub controller 160. As is also shown in FIG. 1, the printer line 188 is connected to the third device port 166. Both the CD writer port 180 and the printer port 186 may be USB-A receptacles. Accordingly, USB cables may connect the peripherals 110 to the docking station 106.

As described above, one of the functions of the hub controller 160 is to route data depending on which devices are connected to the docking station 106. For example, if the hub controller 160 senses that the computer 104 is connected to the docking station 106 and the computer 104 is active, the hub controller 160 may route data as though the computer 104 is the USB host. Accordingly, the hub controller 160 will configure itself so that the host port 162 is connected to the line 173. If, on the other hand, the hub controller 160 detects that the imaging device 108 is connected to the docking station 106 and the computer 104 is either not connected or is not active, the hub controller 160 may route data as though the imaging device 108 is the USB host. Accordingly, the hub controller 160 may configure itself so that the digital imaging device line 178 is connected to the host port 162. This may be achieved by converting the first device port 164 to the host port 162. Switching devices, not shown, within the hub controller 160 may, as an example, serve to properly configure the hub controller 160.

It should be noted that in one embodiment, the docking station 106 may serve as the USB host. In such an embodiment, the image data is transferred from the imaging device 108 to a USB device, such as the printer 116, via the docking station 106. Accordingly, the USB devices may recognize the docking station 106 as the USB host device.

The hub controller 160 may also be connected to sensors and the like that detect which devices are electrically connected to the docking station 106. These sensors are described in greater detail below. A first switching device 168 and a second switching device 169 may also be electrically connected to the hub controller 160. In the non-limiting embodiment of FIG. 1, the first switching device 168 and the second switching device 169 are toggle switches that complete connections to ground upon activation. Activation of the first switching device 168 may cause image data representative of an image located in the imaging device to be routed to the printer 116, thereby causing the printer 116 to print the image. Activation of the second switching device 169 may cause the image data to be saved on the CD writer 114.

The docking station 106 may have a sensor 190. The sensor 190 may be connected to the hub controller 160 by way of a line 192. In the embodiment of the docking station 106 described herein, the sensor 190 may be located in a cradle (not shown in FIG. 1) and may sense the presence of the imaging device 108. Many embodiments of the sensor 190 may be used with the docking station 106. For example, the sensor 190 may be a switching device that toggles when the imaging device 108 is located in the cradle. Likewise, the sensor 190 may use optics to detect the presence of the sensor 190 in the cradle. In another type of embodiment, the sensor 190 may be of the type that detects electric current flowing to the imaging device 108, which is indicative of the imaging device 108 being connected to the docking station 106. For example, the sensor 190 may monitor current being drawn on the line 192.

A non-limiting embodiment of the docking station 106 showing its physical structure is shown in FIG. 3. The docking station 106 may have a housing 196 with a cradle 200 formed therein. In addition, the computer port 170, the CD writer port 180, and the printer port 186 may extend through the housing 196. It should be noted that other connections, not shown, such as a connection for a power source, may also extend through the housing 196. A print button 204 and a save button 205 may also located on or extend through the housing 196. The print button 204 is an example of a device that may be used to toggle or otherwise switch the first switching device 168 of FIG. 1. The save button 205 is an example of a device that may be used to toggle or otherwise switch the second switching device 169 of FIG. 1.

The shape of the cradle 200 may be configured to receive the imaging device 108, FIG. 1. Thus, a user may set the imaging device 108 into the cradle 200 in order to electrically connect the imaging device 108 to the docking station 106. In the embodiment described herein, the cradle 200 is shaped to receive a digital camera. However, it should be understood that the shape of the cradle 200 may be configured to receive other devices, such as digital video cameras.

The cradle 200 may be formed from a plurality of walls. These walls may include a first wall 206 and a second wall 208. A base 210 may extend between the first wall 206 and the second wall 208. The first wall 206 may have a key 212 formed therein, which serves to properly align the imaging device within the cradle 200. It should be noted that the key 212 is only one embodiment of an alignment mechanism and that other alignment mechanisms may be incorporated into the cradle 200. For example, as described above, the shape of the cradle 200 may provide for proper alignment of the imaging device within the cradle 200.

A switch 216 may extend through the base 210 of the cradle 200. The switch 216, in one embodiment, may be a portion of the sensor 190, FIG. 1. The switch 216 may be biased toward a position wherein it extends through the base 210 as shown in FIG. 3. Upon placing the imaging device into the cradle 200, the switch 216 may be forced into the base 210 causing an electrical connection associated with the sensor 190, FIG. 1, to transition. This electrical transition provides an indication that the imaging device is located within the cradle 200 or has been removed from the cradle 200. Thus, the electrical transition provides an indication as to whether the imaging device is electrically connected to the docking station 106.

A plurality of contacts 220 may extend through the base 210 of the cradle 200. The contacts 220, like the switch 216, may be biased to extend through the base 210 of the cradle 200. In the embodiment of the docking station 106 described in FIG. 3, the contacts 220 consist of a first pair of contacts 222, a second pair of contacts 226, and a third pair of contacts 230. As described in greater detail below, the contacts 220 may serve to provide electrical connections between the imaging device, not shown in FIG. 3, and the docking station 106. In the embodiment wherein communications between the docking station 106 and the digital camera are by way of a USB, four of the contacts 220 may be used for such communications. For example, the first pair of contacts 222 may be associated with the power supply conductors 156 of FIG. 2 and the second pair of contacts 226 may be associated with the data conductors 158 of FIG. 2. The third pair of contacts 230 may provide other communications or may charge batteries within the imaging device.

Having described an embodiment of the docking station 106, the operation of the docking station 106 in conjunction with the computer system 100 will now be described. In summary, the docking station 106 may serve as a hub controller that routes data per instructions from a host device. The docking station 106 may also select the device that is to be the host. For example, referring to FIG. 1, if the computer 104 is not connected to the docking station 106 or is inactive, the imaging device 108 may be selected as the host.

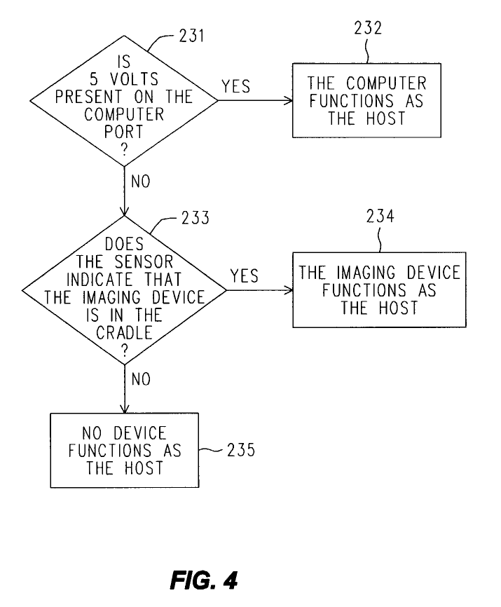

FIG. 4 is a flow chart describing a summary of an embodiment of the operation of the docking station 106 in conjunction with the computer system 100. With additional reference to FIG. 1, block 231 determines whether five volts is present at the computer port 170. If the five volts is present, the computer 104 functions as the host as described in block 232. If, on the other hand, five volts is not present at the computer port 170, block 233 determines whether the sensor 190 is indicating that the imaging device 108 is located in the cradle 200, FIG. 3. If the imaging device 108 is located in the cradle 200, the imaging device 108 functions as the host as described in block 234. If the imaging device is not located in the cradle 200, then no device functions as a host as described in block 235.

The following description is based on communications between components of the computer system 100 being achieved via a USB protocol. It should be noted that the following description may be adapted for use by other communication protocols. In the embodiment of the computer system 100 of FIG. 1, the computer 104 is connectable to the docking station 106 by way of the computer cable 172. The peripherals 110 may be connectable to the docking station 106 by similar cables. The imaging device 108 may be connectable to the docking station 106 by placing it in the cradle 200, FIG. 3, as described above.

Referring to FIG. 1, the hub controller 160 may detect that the computer 104 is electrically connected to the docking station 106 by many different methods. For example, the hub controller 160 may detect whether a preselected voltage, for example, five volts, is present at the computer port 170. As described above, a USB host supplies five volts to USB devices to which it is connected. Other methods of detecting the presence of the computer 104 may include attempts to electrically communicate with the computer 104. If the hub controller 160 determines that the computer 104 is electrically connected to the docking station 106, the hub controller 160 routes data as though the computer 104 is a host device. In the embodiment of the hub controller 160 shown in FIG. 1, the computer 104 is connected to the docking station 106 and is active. Accordingly, the port to which the line 173 is connected is configured to be the host port 162.

The hub controller 160 may also determine whether the imaging device 108 is electrically connected to the docking station 106. In the embodiment described herein, the presence of the imaging device 108 in the cradle 200, FIG. 3, causes the switch 216 to depress, which in turn activates the sensor 190. In such an embodiment, the sensor 190 may be a switch that provides a preselected voltage when the switch 216 is depressed. In the embodiment shown in FIG. 1, the imaging device 108 is connected to the docking station 106 and is configured as a USB device. As described below, if the computer 104 is either not connected to the docking station 106 or is inactive, the hub controller 160 will attempt to activate the imaging device 108 as the USB host if the imaging device 108 is connected to the docking station 106.

In the non-limiting embodiment of the docking station 106 shown in FIG. 1, the hub controller 160 routes data between a USB host, which is the computer 104, and associated USB devices, which are the imaging device 108 and the peripherals 110. A user of the computer may access the imaging device 108 and the peripherals 110 as though they are connected directly to the computer 104. It should be noted that operatively connecting the imaging device 108 to the computer 104 simply involves placing the imaging device 108 into the cradle 200, FIG. 3. Thus, the docking station 106 functions both as a docking station and a data hub.

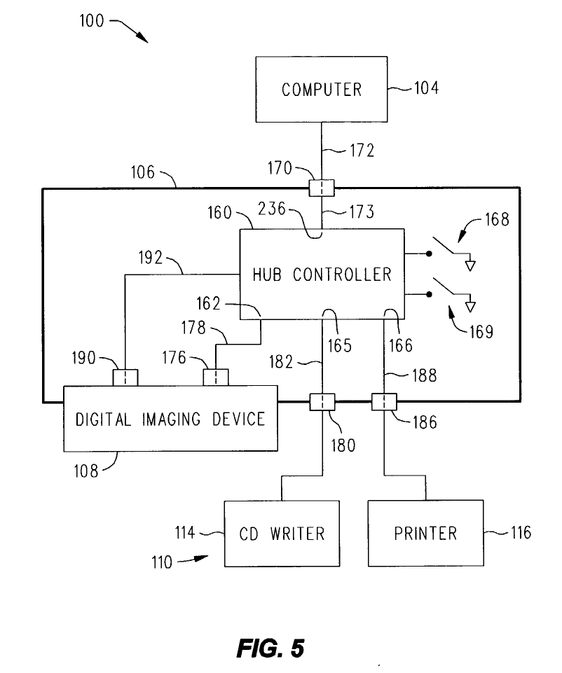

An embodiment of the configuration of computer system 100 with the computer 104, FIG. 1, either disconnected or inactive is shown in FIG. 5. As described above, sensing the connection of the computer 104 to the docking station 106 may be achieved using many different techniques. In the embodiments where communications are performed using the USB protocol, the hub controller 160 may monitor the computer port 170 for the above-described five-volts. As described above, two of the four conductors in a USB cable from a USB host supply five volts to the USB device to which it is connected. In other embodiments, the hub controller 160 may attempt to send data to the computer 104. If the computer 104 does not respond, the docking station 106 may function as though the computer 104 is not connected thereto.

When the hub controller 160 determines that the computer 104 is not connected to the docking station 106 or is inactive, the hub controller 160 is configured or configures itself so that the computer cable 172 is connected to a dormant port 236. Because the computer 104 is not connected to the docking station 106 or is inactive, the hub controller 160 searches for another device to be the host. In the embodiment of FIG. 4, the hub controller 160 may detect that the imaging device 108 is electrically connected to the docking station 106 and may function as though the imaging device 108 is the host. For example, the sensor 190 may detect that the imaging device 108 is located in the cradle 200 of FIG. 2. Accordingly, the port to which the digital imaging device port 176 is connected is the host port 162.

When the imaging device 108 functions as the host, the printer 116 may function as though it is directly connected to the imaging device 108. This may be achieved by the hub controller 160 connecting the digital imaging device line 178 to the printer line 188. The imaging device 108 will then be operatively connected to the printer 116. Images represented by image data stored on the imaging device 108 may be printed by transmitting the image data to the printer 116. For example, the imaging device 108 may have a button of the like that, when activated, causes data to be routed to a printer. The imaging device 108 may also have a button or the like that, when activated, causes image data to be routed to the CD writer 114. Accordingly, activating the button may cause an image to be saved.

Having described some embodiments of the computer system 100, other embodiments will now be described.

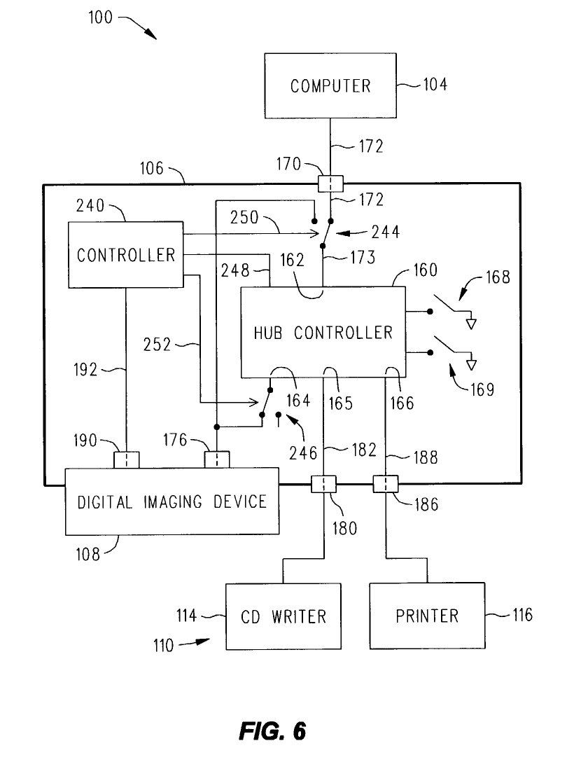

An embodiment of the docking station 106 having a controller 240 is shown in FIG. 6. In addition to the controller 240, the docking station 106 has third switching device 244 and a fourth switching device 246 operatively connected to the controller 240. In the embodiment of the hub controller 160 of FIG. 6, the hub controller 160 is not configurable. More specifically, the location of the host port 162 remains constant. The controller 240 in conjunction with the third switching device 244 and the fourth switching device 246 determine which device is to be connected to the host port 162.

The sensor 190 is connected to the controller 240 by way of the line 192. Accordingly, the controller 240 determines whether the imaging device 108 is connected to the docking station 106. A line 248 may be connected to the hub controller 160 and may provide information regarding whether the computer 104 is connected to the docking station 106 and whether the computer 104 is in an active state.

A line 250 and a line 252 may connect the controller 240 to the third switching device 244 and the fourth switching device 246 respectively. The third switching device 244 and the fourth switching device 246 may be electronic switches controlled by signals on the line 250 and the line 252 respectively.

Having described the embodiment of the computer system 100 of FIG. 6, its operation will now be described.

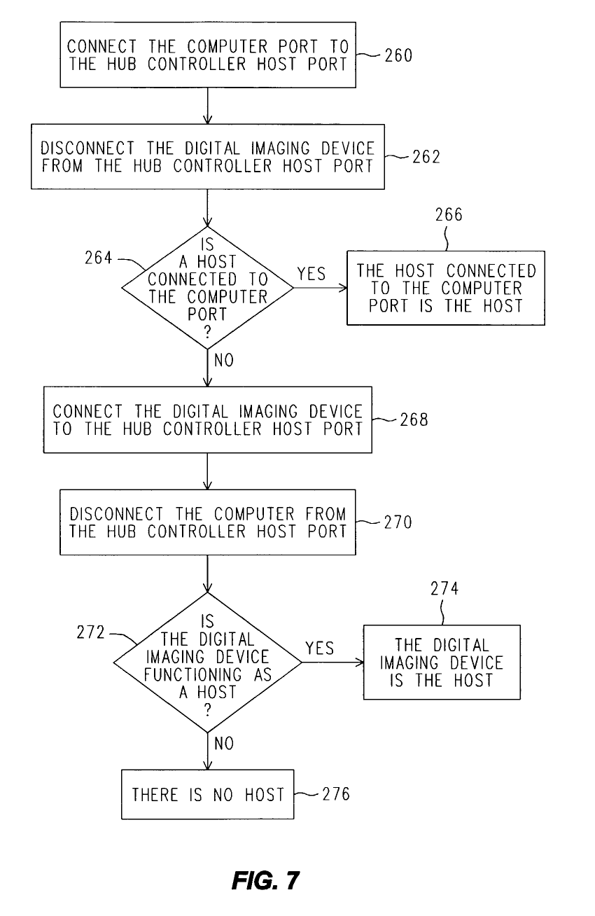

A flowchart summarizing an embodiment of the operation of the computer system 100 of FIG. 6 is shown In FIG. 7. With reference to FIGS. 6 and 7, the controller 240 causes the switching device 244 to connect the computer port 170 to the host port 162 as described in block 260. Simultaneously, the switching device 244 disconnects the imaging device 106 from the host port 162 as described in block 262. Block 264 determines whether a host device is connected to the computer port 170. If a host is connected to the computer port 170, the host connected thereto functions as the host for the computer system 100 as described in block 266. If, on the other hand, a host is not connected to the computer port 170, the controller 240 causes the switching device 244 to connect the imaging device 108 to the host port 162 as described in block 268. Simultaneously, the switching device 244 disconnects the computer port 170 from the host port 168 as described in block 270. A decision is made at block 272 as to whether the imaging device 108 functions as a host device. If so, the imaging device 108 serves as the host for the computer system 100 as described in block 274. If not, there is no host available for the computer system 100 as described in block 276.

Having summarily described the computer system 100, it will now be described in greater detail. The controller 240 causes the third switching device 244 to toggle so that the computer port 170 is connected to the host port 162 and the imaging device 108 is not connected to the host port 162. The controller 240 may also cause the fourth switching device 246 to toggle so that the imaging device 108 is connected to first device port 164. The hub controller 160 then detects whether a host is connected to the computer port 170. Detecting the host connected to the computer port 170 may be achieved by the controller 240 transmitting a signal to the hub controller 160 via the line 248. The signal may initiate the hub controller 160 to determine whether the host is connected as described above with reference to FIG. 1. The determination as to whether a host is connected to the computer port 170 may be transmitted to the controller 240 by way of the line 248. If a host is connected to the computer port 170 the controller 240 leaves the third switching device 244 and the fourth switching device 246 in their positions.

If the controller 240 determines that the computer 104 is either not connected to the docking station 106 or is inactive, it determines whether the imaging device 108 may be a host. If the sensor 190 indicates that the imaging device 108 is located in the cradle 200, FIG. 3, the controller 240 will toggle the third switching device 244 and the fourth switching device 246. This toggling disconnects the computer port 170 from the host port 162 and connects the imaging device 108 to the host port 162. The toggling further disconnects the docking station 106 from the first device port 164. The hub controller 160 may determine whether the imaging device 108 is active in a manner similar to the manner in which it determines whether the computer 104 is active. If the imaging device 108 is active, the computer system 100 may function as though the imaging device 108 is the host.

As described above, printing may be achieved by a user pressing the print button 204, FIG. 3. Pressing the print button 204 may cause an instruction to be transmitted to the imaging device 108, which causes it to output image data representative of a preselected image. For example, the imaging device 108 may have a display device (not shown) that displays an image stored within the imaging device 108. Upon receipt of the above-described instruction, the imaging device 108 may output the image data representative of this image. The image data may be transmitted to the printer 116, which prints the image based on the image data.

In the embodiment of the docking station 106 of FIG. 6, pressing the print button 204, FIG. 3 may cause the controller 240 to make the imaging device 108 the host. This is achieved by causing the third switching device 244 to connect the imaging device 108 to the host port 162 as described above. Pressing the print button 204, FIG. 3, may also cause instructions to be sent to the imaging device 108 causing it to output image data to the docking station 106. For example, the imaging device 108 may have a display, not shown. Image data representative of the image on the display may be sent to the printer to print the image. Accordingly, printing may be achieved without operating the computer or any computer programs. Additionally, the printer 116 does not need to be disconnected from the docking station 106 and reconnected to the imaging device 108 for the printing operation.

In one embodiment, saving image data may be achieved by pressing the save button 205, FIG. 3. Pressing the save button 205 may cause the computer system 100 function in a similar manner as pressing the print button 204. However, the image data is routed to the CD writer 114 instead of the printer 116. Accordingly, a user may save image data without the need of accessing or activating the computer 104.

Referring to FIG. 3, the cradle 200 has been described as having a switch 216 located therein to indicate that the imaging device is located in the cradle 200. Other embodiments are available to indicate the presence of the imaging device within the cradle 200. For example, light detectors located in the cradle 200 may indicate the presence of a shadow caused by the imaging device within the cradle 200. In another embodiment, current sensor may detect current flowing through the contacts 220, which indicates that the imaging device is connected to the docking station 106.

The computer system 100 has been described herein as using USB protocol for communications between the components. In some embodiments, other protocols may be used for communications. These other protocols may use voltages other than the five volts used in the USB protocol. In some protocols, no voltages other than those used for signal transmissions are provided. In addition, communications may be accomplished by wireless methods, such a radio frequency and infrared communications.

In another embodiment of the docking station 106, the host is manually selectable. In such an embodiment, the docking station 106 may have a switch or the like located thereon. Activation of the switch may cause the third device port 166 to select the host regardless of whether the computer 104 is connected to the docking station 106 or not.

What is claimed is:

1. A docking station for peripheral devices comprising:
a first port connectable to a computer; and
a second port connectable to a digital imaging device; and
at least one third port connectable to at least one peripheral device;
wherein said computer functions as a host for said at least one peripheral device when said computer is connected to said first port; and
wherein said digital imaging device functions as a host for said at least one peripheral device when said computer is not connected to said first port and said digital imaging device is connected to said second port.

2. The docking station of claim 1, wherein said at least one peripheral device is a printer.

3. The docking station of claim 1, wherein said at least one peripheral device is a data storage device.

4. The docking station of claim 1, wherein said computer is connectable to said first port by way of a Universal Serial Bus.

5. The docking station of claim 1, wherein said digital imaging device is connectable to said second port by way of a Universal Serial Bus.

6. The docking station of claim 1, and further comprising a first switching device operatively connected to said at least one peripheral device, wherein activation of said first switching device causes said host to transmit data to said at least one peripheral device.

7. The docking station of claim 6, wherein activation of said first switching device further causes said at least one peripheral device to function.

8. The docking station of claim 1, and further comprising a cradle, said cradle being configured to receive said digital imaging device.

9. The docking station of claim 8, wherein said second port is located in said cradle and wherein said imaging device is connectable to said second port when said imaging device is received in said cradle.

10. The docking station of claim 1, and further comprising a second switching device, wherein activation of said second switching device causes data to be transferred from said second port to said at least one third port.

11. The docking station of claim 1, and further comprising a third switching device and a hub controller, said hub controller comprising a host port connectable to a host, said third switching device connecting said first port to said host port when said computer is connected to said first port, and said third switching device connecting said second port to said host port when said digital imaging device is connected to said second port.

12. The docking station of claim 11, wherein said third switching device connects said first port to said host port when said computer is connected to said first port and said computer is active.

13. The docking station of claim 11, wherein said third switching device connects said second port to said host port when said digital imaging device is connected to said second port and said computer is inactive.

14. A method for transmitting image data from an imaging device to a peripheral device, said method comprising:
electrically connecting said imaging device to a docking station;
electrically connecting a printing device to said docking station;
detecting whether a computer is connected to said docking station;
enabling said imaging device to function as a host if said computer is not connected to said docking station;
enabling said computer to function as a host and transmitting said image data to said computer if said computer is connected to said docking station; and
transmitting said image data from said host to said printer, said transmitting causing said printer to print an image represented by said image data.

15. The method of claim 14, and further comprising detecting if said computer is active, and wherein said enabling said computer comprises enabling said computer to function as a host if said computer is connected to said docking station and said computer is active.

16. The method of claim 14, wherein the connection between said computer and said docking station comprises a direct current voltage supplied by said computer to said docking station, and wherein said detecting whether a computer is connected to said docking station comprises detecting whether said computer is supplying said direct current voltage to said docking station.

17. The method of claim 14, wherein said detecting whether a computer is connected to said docking station comprises attempting to communicate with said computer via said docking station.

18. The method of claim 14, and further comprising activating a switching device and wherein said transmitting comprises transmitting said image data from said host to said printer upon activation of said switching device, said transmitting causing said printer to print an image represented by said image data.

19. A method of operating a docking station, said method comprising:
electrically connecting an imaging device to said docking station;
electrically connecting at least one peripheral device to said docking station;
detecting whether a computer is connected to said docking station;
enabling said imaging device to function as a host if said computer is not connected to said docking station; and
enabling said computer to function as a host if said computer is connected to said docking station.

20. The method of claim 19, wherein said electrically connecting at least one peripheral device comprises electrically connecting a printer to said docking station.

21. The method of claim 19, wherein said electrically connecting at least one peripheral device comprises electrically connecting a data storage device to said docking station.

22. The method of claim 19, wherein the connection between said computer and said docking station comprises a direct current voltage supplied by said computer to said docking station, and wherein said detecting whether a computer is connected to said docking station comprises detecting whether said computer is supplying said direct current voltage to said docking station.

23. The method of claim 19, wherein said detecting whether a computer is connected to said docking station comprises attempting to communicate with said computer via said docking station.

24. The method of claim 19, and further comprising transmitting data between said imaging device and said at least one peripheral device upon activation of a switching device.

25. A docking station comprising
a first port connectable to a computer;
a second port connectable to an imaging device;
at least one third port connectable to at least one peripheral device;
a first detecting means for detecting whether said computer is connected to said first port; and
a first switching means for enabling said computer to function as a host if said computer is connected to said docking station and for enabling said imaging device to function as a host if said computer is not connected to 10 said docking station.

26. The docking station of claim 25 and further comprising a second switching means for transferring data between said imaging device and said at least one peripheral device upon activation of said second switching means.

27. The docking station of claim 25, wherein a preselected voltage is supplyable by said computer to said first port and wherein said first detecting means comprises a voltage measuring means for measuring said preselected voltage.

28. The docking station of claim 25 and further comprising a second detecting means for detecting whether said imaging device is connected to said second port.
